(19) United States
(12) Patent Application Publication
(10) Pub. No.: US 2026/0166683 A1
(43) Pub. Date: Jun. 18, 2026

(54) LIMITATION STRUCTURE FOR INTERNAL HOLE OF HAND TOOL

(71) Applicant: JIN WANG INDUSTRIAL COMPANY, LTD., Taichung City (TW)

(72) Inventor: TE-CHUAN YANG, Taichung City (TW)

(21) Appl. No.: 18/986,193

(22) Filed: Dec. 18, 2024

(51) Int. Cl. B25B 13/46; B25B 23/00

(52) U.S. Cl. CPC B25B 13/462; B25B 23/0035

(57) ABSTRACT

A limitation structure for an internal hole of a hand tool contains a wrench and a limiter. The wrench includes a handle and a work segment with a ratchet which has the internal hole. The internal hole has a groove, and the limiter includes an oval ring, an opening, a long axis, and a short axis. The oval ring has a virtual central point, and a first engagement portion is formed on the long axis. The limiter further includes a second engagement portion, a third engagement portion, and two flexible clamp portions formed on two ends of the short axis and located within 60 degrees to 90 degrees of a first angle of the virtual central point. The opening is located within 10 degrees to 90 degrees of a second angle of the virtual central point, and the limiter is received in the groove.

### TECHNICAL FIELD

The present invention relates to a hand tool, and more particularly to a limitation structure for an internal hole of the hand tool.

### BACKGROUND

A ratchet wrench is a commonly used hand tool mainly used to tighten or loosen nuts and screws. It is characterized by a ratchet mechanism configured to obtain continuous rotational operations without moving the hand tool. In other words, users are capable of connecting or removing quickly and easily in a small space.

The ratchet wrenches are classified in many sizes and types, including open-end wrenches, socket wrenches, etc. They are designed to allow users to exert forces effectively by simply turning the ratchet wrenches, thus improving work efficiency. When using a socket wrench, the users can select a suitable socket according to a size of a nut or a screw, insert it into the working segment of the ratchet wrench, and fix the socket by using a clamping structure inside the working segment, such that the users only need to hold and rotate the ratchet wrench so as to drive the socket to rotate, thus tightening or loosening the nut or the screw.

As shown in FIGS. 12-14, a conventional socket wrench contains a body 91 and limiter 92, wherein the body 91 includes a handle 911 and a work segment 912, the work segment 912 has a ratchet 913 in which an internal hole 914 is defined to accommodate a socket, the internal hole 914 has a groove 915 formed on an inner wall thereof, and the limiter 92 is in a C shape so as to create a circular ring and an opening, thus obtaining a specific flexibility. A diameter of the limiter 92 is smaller than a diameter of the groove 915 and is accommodated in the groove 915, and an inner wall of the limiter 92 projects out of the internal hole 914. In use, the socket is inserted into the internal hole 914 and is fixed by the limiter 92.

The diameter of the limiter 92 of the conventional socket wrench is smaller than the diameter of the groove 915 so that when the body 91 is inserted to connect with the socket at a horizontal angle, the limiter 92 is adjustable automatically to guide the socket into the internal hole 914. As illustrated in FIGS. 15 and 16, when moving the body 91 vertically, the limiter 92 slides downward in the groove 915 because of gravity, hence the limiter 92 is not aligned with the groove 915 to cause an obstruction for inserting the socket and an inconvenient operation. When the limiter 92 slides in the groove 915, noises will be made to reduce user experience.

The present invention has arisen to mitigate and/or obviate the afore-described disadvantages.

### SUMMARY

The primary aspect of the present invention is to provide a limitation structure for an internal hole of a hand tool by which a limiter is engaged with an inner wall of a groove in a three-point positioning manner by using a first engagement portion, a second engagement portion, and a third engagement portion so that no matter what angle a wrench is at, the limiter is aligned with the groove, and a socket is inserted into the internal hole smoothly to enhance a using convenience.

Another aspect of the present invention is to provide a limitation structure for an internal hole of a hand tool which is capable of avoiding a slide and a sliding noise of the limiter in the groove.

To obtain the above-mentioned aspects, a limitation structure for an internal hole of a hand tool provided by the present invention contains a wrench and a limiter.

The wrench includes a handle and a work segment, the work segment includes a ratchet that has the internal hole, the internal hole has a groove defined on an inner wall thereof, and the ratchet has a protruded portion and a recessed portion spaced from the protruded portion.

The limiter includes an oval ring and an opening defined inside the oval ring, such that the oval ring is flexibly deformed. The oval ring has a virtual central point, the limiter includes a long axis and a short axis, the opening is located at an end of the long axis, and a first engagement portion is formed on the other end of the long axis. The limiter further includes a second engagement portion and a third engagement portion which are formed on two ends of the opening, and the limiter includes two flexible clamp portions formed on two ends of the short axis and located within 60 degrees to 90 degrees of a first angle of the virtual central point. The opening is located within 10 degrees to 90 degrees of a second angle of the virtual central point, and the limiter is received in the groove. The first engagement portion, the second engagement portion and the third engagement portion are engaged with an inner wall of the groove to form a three-point positioning, and the two flexible clamp portions of the first angle project out of the recessed portion so that the first angle of the inner hold produces a flexible clamping effect.

### BRIEF DESCRIPTION OF THE DRAWINGS

FIG. 1 is a perspective view showing the assembly of a limitation structure for an internal hole of a hand tool according to a preferred embodiment of the present invention.

FIG. 2 is a perspective view showing the exploded components of the limitation structure for the internal hole of the hand tool according to the preferred embodiment of the present invention.

FIG. 3 is a side plan view showing the assembly of a limiter of the limitation structure for the internal hole of the hand tool according to the preferred embodiment of the present invention.

FIG. 4 is a side plan view showing the assembly of the limitation structure for the internal hole of the hand tool according to the preferred embodiment of the present invention.

FIG. 5 is a cross-sectional view taken along the line A-A of FIG. 4.

FIG. 6 is a cross-sectional view taken along the line B-B of FIG. 4.

FIG. 7 is a perspective view showing the operation of the limitation structure for the internal hole of the hand tool according to the preferred embodiment of the present invention.

FIG. 8 is a cross-sectional view showing the operation of the limitation structure for the internal hole of the hand tool according to the preferred embodiment of the present invention.

FIG. 9 is another cross-sectional view showing the operation of the limitation structure for the internal hole of the hand tool according to the preferred embodiment of the present invention.

FIG. 10 is also another cross-sectional view showing the operation of the limitation structure for the internal hole of the hand tool according to the preferred embodiment of the present invention.

FIG. 11 is still another cross-sectional view showing the operation of the limitation structure for the internal hole of the hand tool according to the preferred embodiment of the present invention.

FIG. 12 is a perspective view showing the exploded components of a conventional socket wrench.

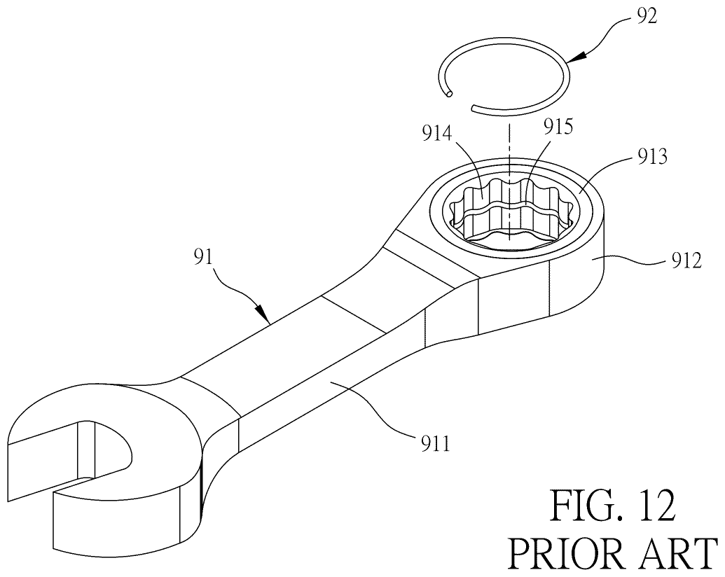

FIG. 13 is a cross-sectional view showing the assembly of the conventional socket wrench in a horizontal state.

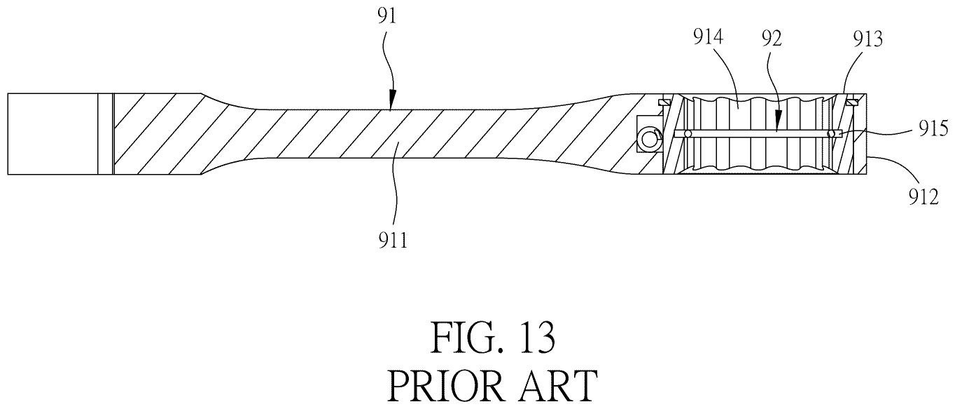

FIG. 14 is a side plan view showing the assembly of the conventional socket wrench in the horizontal state.

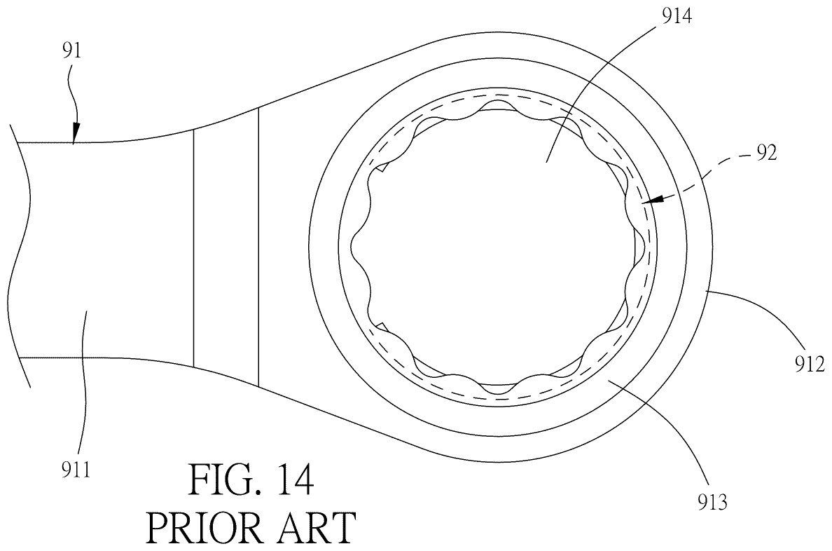

FIG. 15 is a cross-sectional view showing the assembly of the conventional socket wrench in a vertical state.

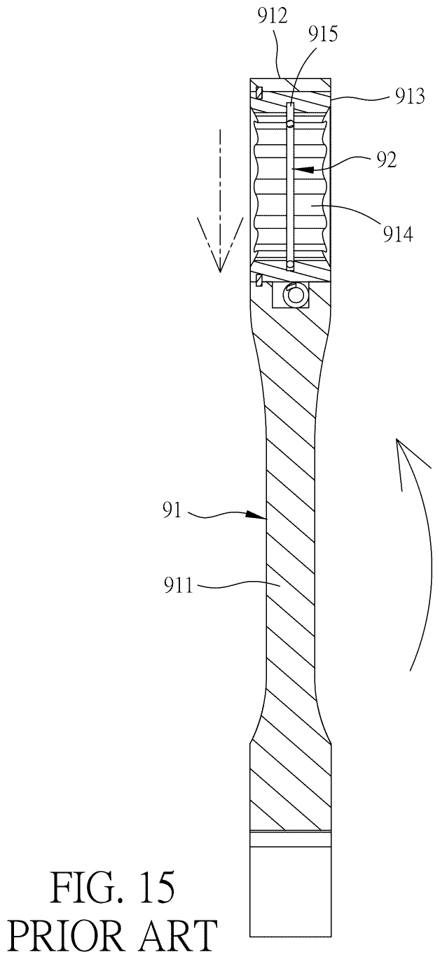

FIG. 16 is a side plan view showing the assembly of the conventional socket wrench in the vertical state.

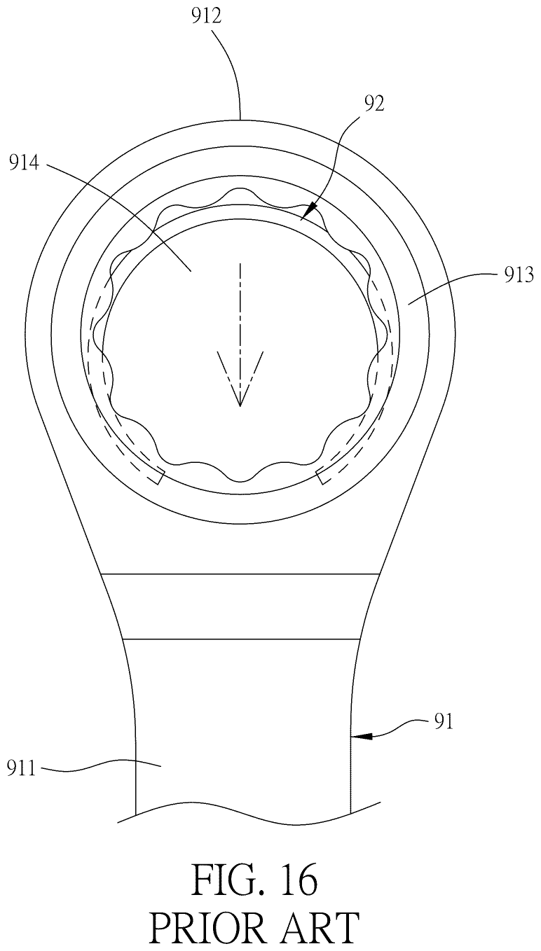

### DETAILED DESCRIPTION

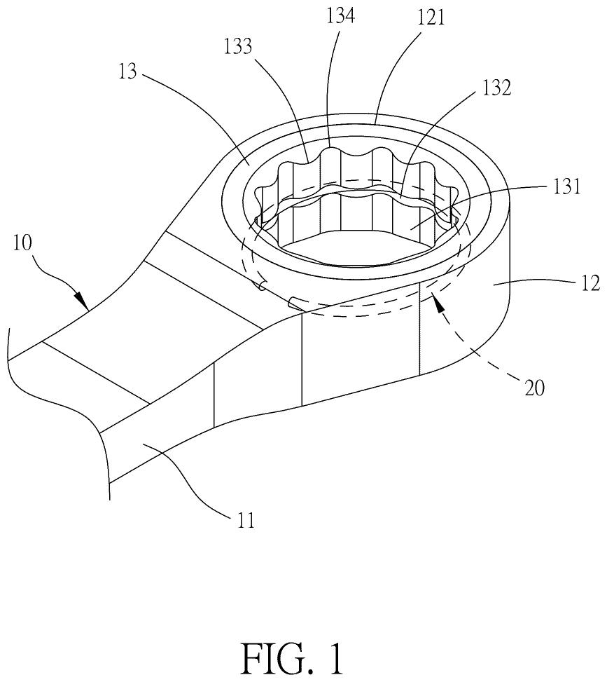

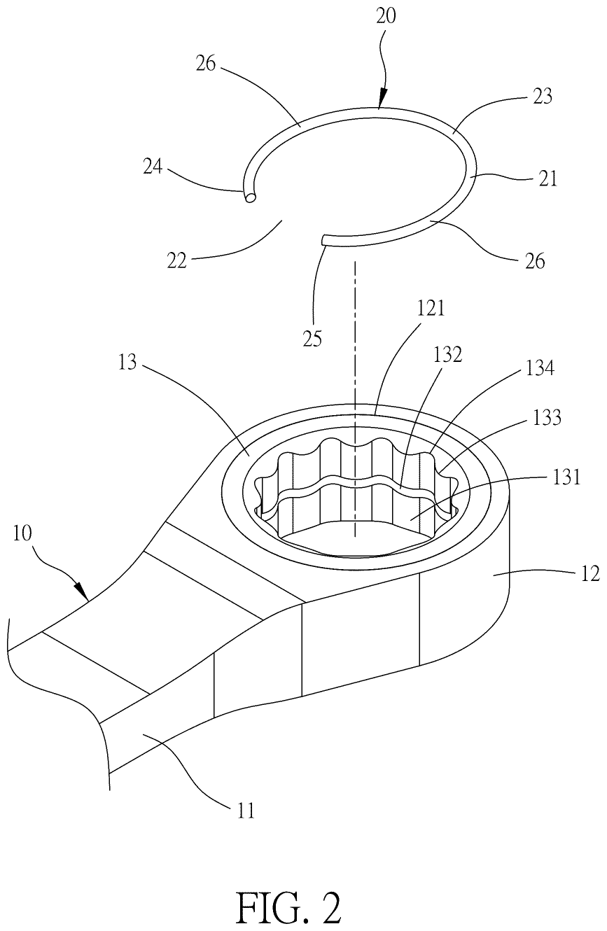

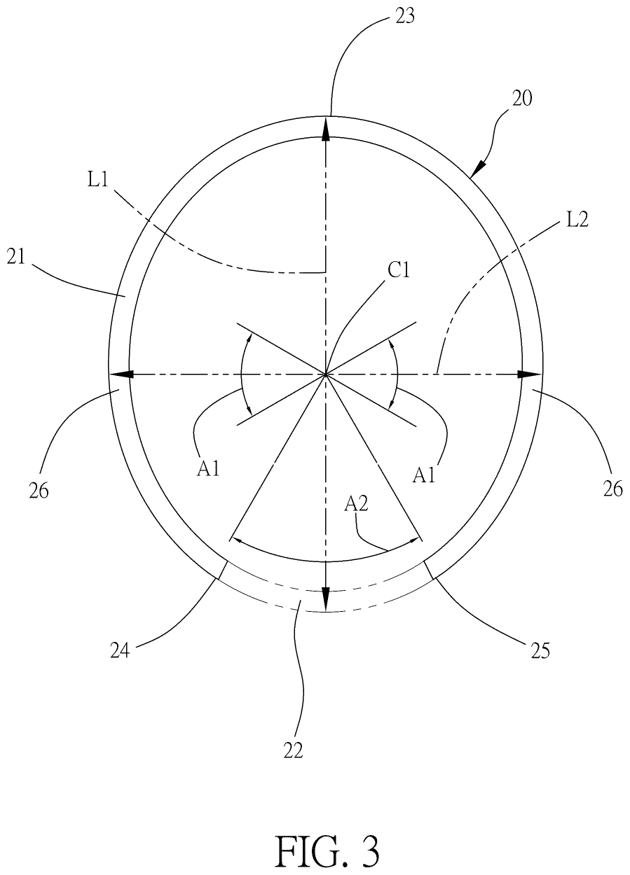

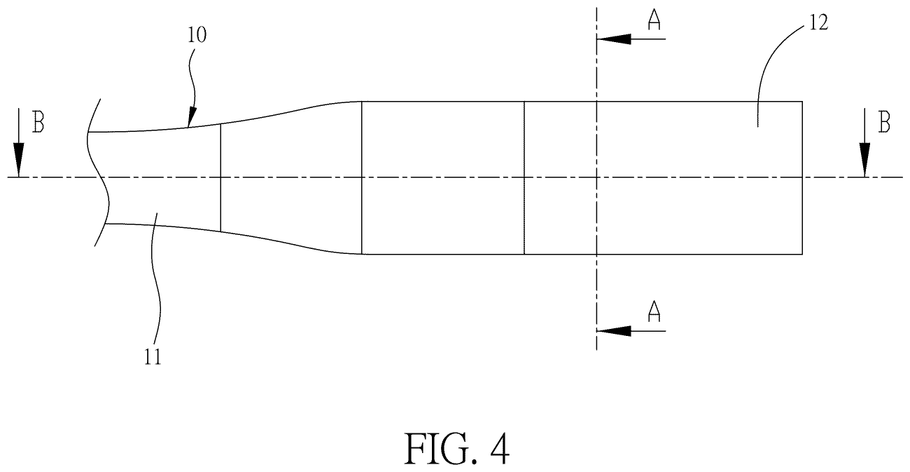

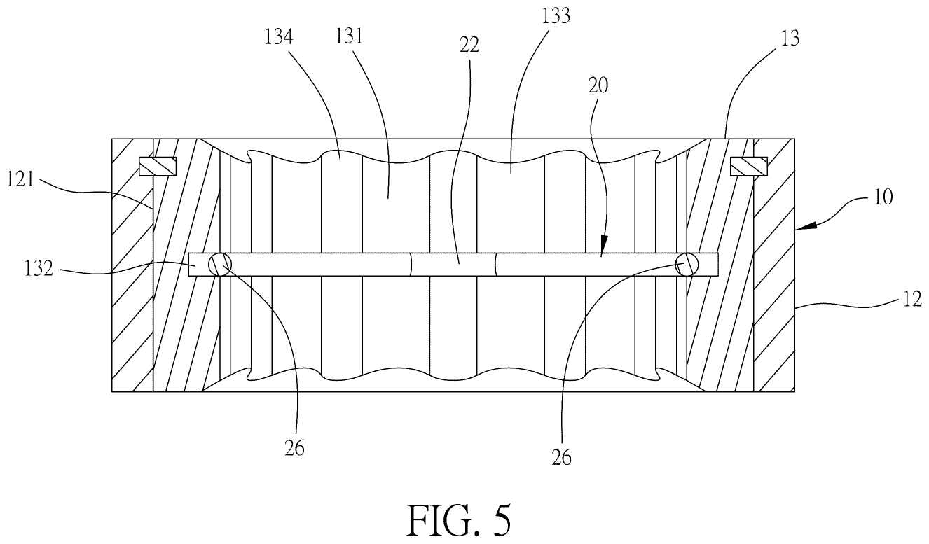

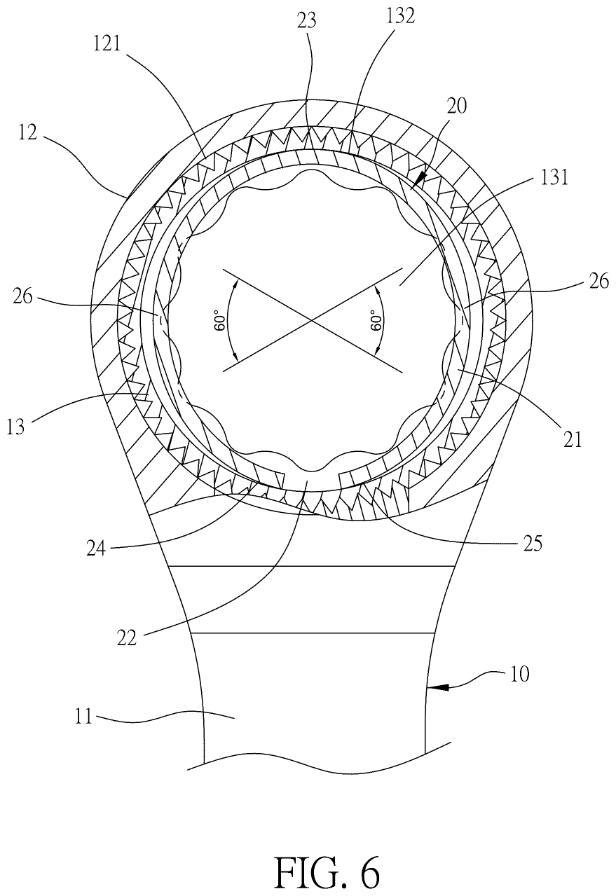

With reference to FIGS. 1-6, a limitation structure for an internal hole of a hand tool according to a preferred embodiment of the present invention comprises a wrench 10 and a limiter 20.

The wrench 10 includes a handle 11 and a work segment 12, the work segment 12 includes a receiving orifice 121 configured to receive a ratchet 13, and the ratchet 13 has the internal hole 131, wherein the internal hole 131 has a groove defined on an inner wall thereof, and the ratchet 12 has a protruded portion 133 and a recessed portion 134 spaced from the protruded portion 133. In this embodiment, the internal hole 131 is polygonal.

The limiter 20 is in a horseshoe shape, and the limiter 20 includes an oval ring 21 and an opening 22 defined inside the oval ring 21, such that the oval ring 21 is flexibly deformed, and the oval ring 21 has a virtual central point C1, wherein the limiter 20 includes a long axis L1 and a short axis L2, a length of the long axis L1 is greater than a diameter of the groove 132, and a length of the short axis L2 is smaller than the diameter of the groove 132, the opening 22 is located at an end of the long axis L1, and a first engagement portion 23 is formed on the other end of the long axis L1, the limiter 20 further includes a second engagement portion 24 and a third engagement portion 25 which are formed on two ends of the opening 22, and the limiter 20 includes two flexible clamp portions 26 formed on two ends of the short axis L2 and located within 60 degrees to 90 degrees of a first angle A1 of the virtual central point C1, wherein the opening 22 is located within 10 degrees to 90 degrees of a second angle A2 of the virtual central point C1. The limiter 20 is received in the groove 132, the first engagement portion 23, the second engagement portion 24 and the third engagement portion 25 are engaged with an inner wall of the groove 132 to form a three-point positioning, the two flexible clamp portions 26 of the first angle A1 project out of the recessed portion 134 so that the first angle A1 of the inner hold 131 produces a flexible clamping effect. In this embodiment, the limiter 20 is bent and made of a flexible metal bar, wherein a cross-section of the flexible metal bar is circular, the opening 22 is located at 60 degrees of the second angle A2 of the virtual central point C1.

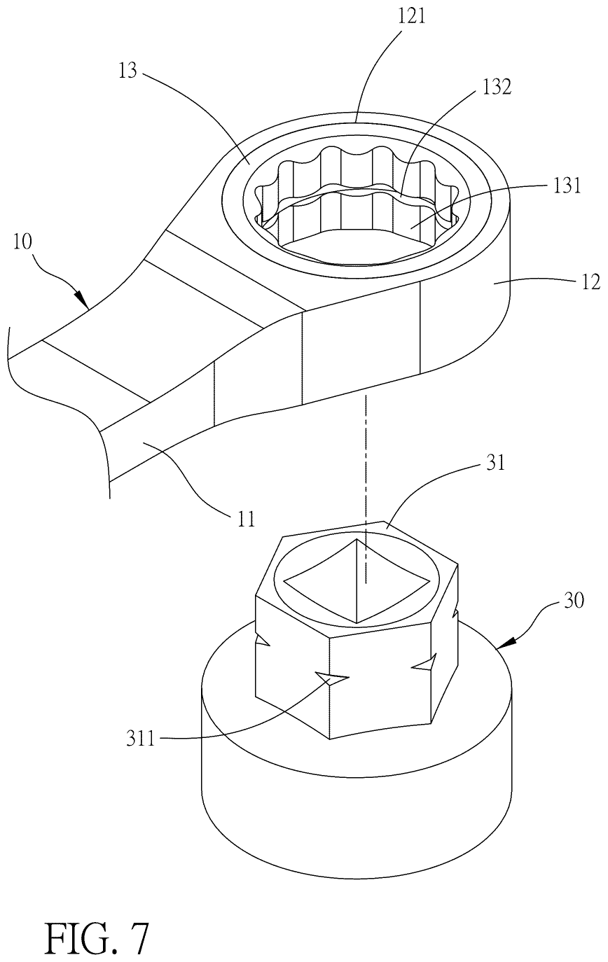

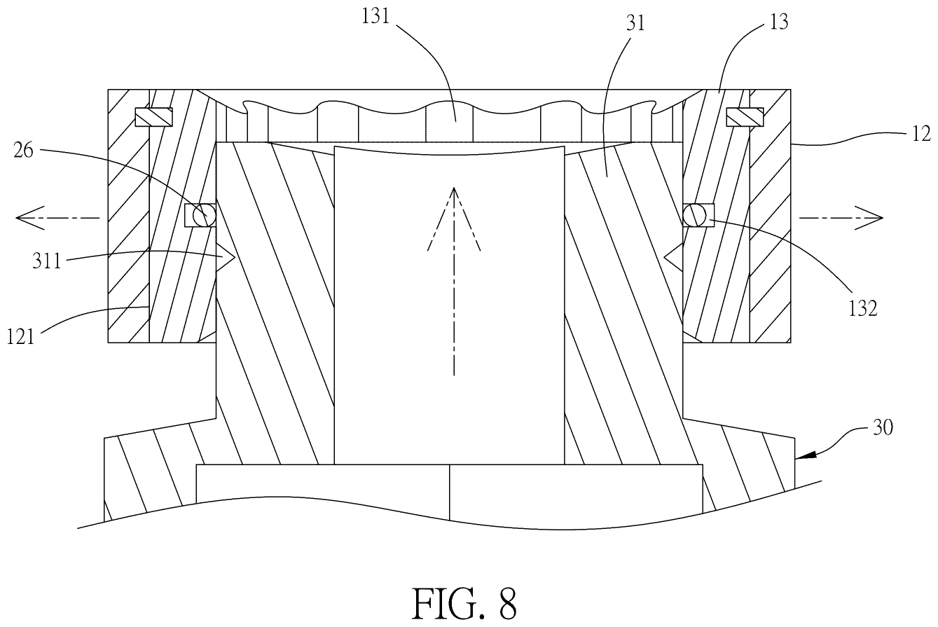

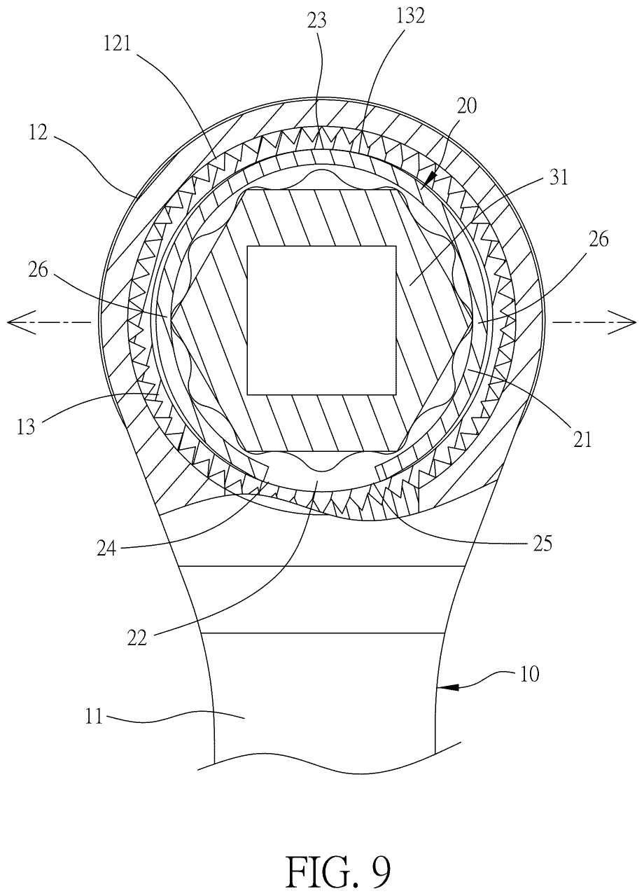

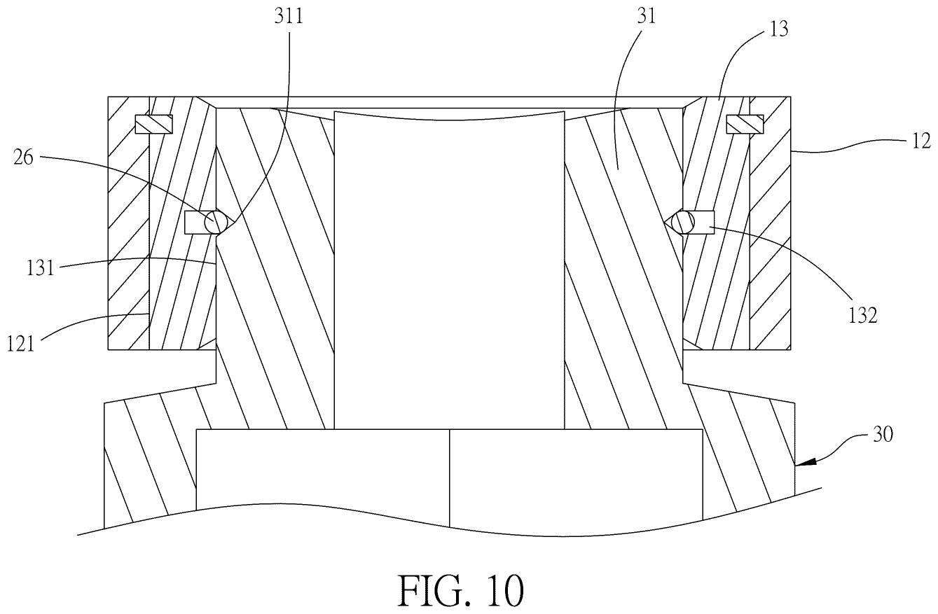

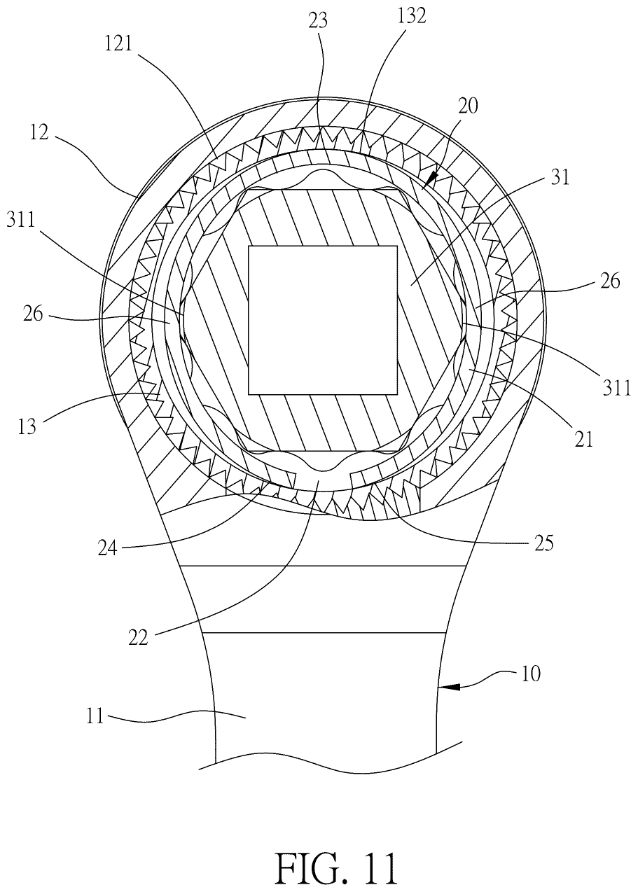

Referring to FIGS. 7-11, a socket 30 includes a coupling column 31 which is hexagonal and has multiple recesses 311 defined on an outer wall of the coupling column 31. When the coupling column 31 is inserted into the internal hole 131, the coupling column 31 forces the two flexible clamp portions 26 of the limiter 20 to expand outward and deform, then the two flexible clamp portions 26 are retracted into the groove 132. After the coupling column 31 is inserted into a predetermined position of the internal hole 131, the limiter 20 deforms flexibly to return to an original shape so that the two flexible clamp portions 26 project out of the internal hole 131 and engage with the multiple recesses 311, thus finishing a positioning and a connection. Since the first angle A1 of the two flexible clamp portions 26 is within 60 degrees to 90 degrees, an angle between any two adjacent surfaces of six surfaces of the outer wall of the coupling column 31 is 60 degrees so that the coupling column 31 is clamped and positioned by the two flexible clamp portions 26.

In contrast, as desiring to remove the socket 30, the coupling column 31 is pulled outward so that the two flexible clamp portions 26 of the limiter 20 are removed from the multiple recesses 311 to expand and retract into the groove 132, thus removing the socket 30.

Thereby, the limitation structure of the present invention has advantages as follows:
1) The limiter 20 is engaged with the inner wall of the groove 132 in a three-point positioning manner by using the first engagement portion 23, the second engagement portion 24, and the third engagement portion 25 so that no matter what angle the wrench 10 is at, the limiter 20 is aligned with the groove 132, and the socket 30 is inserted into the internal hole 132 smoothly to avoid interference of the limiter 30, thus enhancing a using convenience.
2) The limiter 20 is engaged with the inner wall of the groove 132 securely to avoid a slide and a sliding noise of the limiter 20 in the groove 132.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A limitation structure for an internal hole of a hand tool comprising:
a wrench including a handle and a work segment, the work segment including a ratchet which has an internal hole, wherein the internal hole has a groove defined on an inner wall thereof, and the ratchet has a protruded portion and a recessed portion spaced from the protruded portion; and
a limiter including an oval ring and an opening defined inside the oval ring, such that the oval ring is flexibly deformed, wherein the oval ring has a virtual central point, the limiter includes a long axis and a short axis, the opening is located at an end of the long axis, and a first engagement portion is formed on the other end of the long axis, the limiter further includes a second engagement portion and a third engagement portion which are formed on two ends of the opening, and the limiter includes two flexible clamp portions formed on two ends of the short axis and located within 60 degrees to 90 degrees of a first angle of the virtual central point, wherein the opening is located within 10 degrees to 90 degrees of a second angle of the virtual central point, and the limiter is received in the groove, wherein the first engagement portion, the second engagement portion and the third engagement portion are engaged with an inner wall of the groove to form a three-point positioning, and the two flexible clamp portions of the first angle project out of the recessed portion so that the first angle of the inner hold produces a flexible clamping effect.

2. The limitation structure as claimed in claim 1, wherein a length of the long axis is greater than a diameter of the groove, and a length of the short axis is smaller than the diameter of the groove.

3. The limitation structure as claimed in claim 1, wherein the limiter is bent and made of a flexible metal bar.

4. The limitation structure as claimed in claim 3, wherein a cross-section of the flexible metal bar is circular.

5. The limitation structure as claimed in claim 1, wherein the work segment includes a receiving orifice configured to receive the ratchet.

6. The limitation structure as claimed in claim 1, wherein the opening is located at 60 degrees of the second angle of the virtual central point.
